(19) United States
(12) Patent Application Publication
(10) Pub. No.: US 2021/0201368 A1
(43) Pub. Date: Jul. 1, 2021

(54) Combined Ratings and Reviews Widget

(71) Applicant: Ishaque Thanawalla, Bayside, NY (US)

(72) Inventor: Ishaque Thanawalla, Bayside, NY (US)

(21) Appl. No.: 17/134,935

(22) Filed: Dec. 28, 2020

Related U.S. Application Data
(60) Provisional application No. 62/954,297, filed on Dec. 27, 2019.

(51) Int. Cl. G06Q 30/02; G06F 40/40

(52) U.S. Cl. CPC G06Q 30/0282; G06F 40/40; G06Q 30/0203

(57) ABSTRACT

A method offers an online platform to generate an overall rating using various quantitative data and non-quantitative information of a business. The rating includes reputation rating, credibility rating, industry standing, customer satisfaction rating, any combined rating thereof. The rating incorporates numerous ratings by third-party organizations, chambers of commerce, business bureaus, government entities, independent rating/ranking organizations, etc. By acquiring information and data from internal and external sources, the method dynamically creates the business rating through computation with and without weighting factors, and natural language processing (NLP) technology that is used to convert non-quantitative information into quantitative values. Further, the method combines the resulting rating with relevant business information into a rating widget, configured to form a dynamic and interactive display in multiple numerical and graphical formats. Thus, the method offers an overall business rating that facilitates an informed decision-making about the reputability and professionalism of the business.

The current application claims a priority to the U.S. Provisional Patent application Ser. No. 62/954,297 filed on Dec. 27, 2019.

### FIELD OF THE INVENTION

The present invention relates generally to rating methods and systems. More specifically, the present invention relates to a method and system for providing online assessments of business reputation.

### BACKGROUND OF THE INVENTION

A system that shows aggregate ratings for businesses, especially online business websites is in demand. As Internet users spend increasing amounts of time using online marketplaces, people are engaging in a wide variety of transaction types online (e.g., buying, selling, trading, auctioning, etc.).

Ascertaining the reputability and credibility of any given business is a complicated undertaking, because data for business reputability and credibility are neither standardized nor normalized, and existing data sources provide independent, disjointed views of select entities.

Consumers might well have too little time to piece together enough business credibility data from varied sources to generate an accurate overall credibility rating for each business with which they wish to interact. Nor do businesses generally have the tools needed to continually scour the wide range of existing credibility data sources, aggregate credibility data, and provide an independent view of their own credibility to consumers.

Even when credibility data are properly aggregated, providing an overall view of a business's credibility to consumers is an overwhelming task owing to the vast quantities of credibility data available, as well as their nonuniform nature.

Currently, there is no way for businesses or consumers to obtain business credibility assessment scores from all online information sources. Instead, they must review potentially hundreds or even thousands of webpages, perusing reviews and comments to establish a general idea or overview of a particular business. Furthermore, information relevant to a particular business may be difficult to find, hindering accurate assessment of the business.

Accordingly, there is a need to develop a system that provides accurate and up-to-date business review assessment scores for businesses, offering a comprehensive view of their credibility. The present invention aims to solve the aforementioned problems and/or improve on conventional systems by integrating interactive web languages and business-specific information to provide an innovative business rating system.

### SUMMARY OF THE INVENTION

The present invention provides a method and online platform that generate an overall business rating using various quantitative data and non-quantitative information of a specific business. The business rating may include, but is not limited to, reputation rating/ranking, credibility rating, industry standing, customer satisfaction rating, any combined rating thereof. Additionally, the business rating of the present invention may incorporate any rating by a third-party organization, chamber of commerce, business bureau, any other government entity, any independent rating/ranking organization, etc.

The business rating offered by the present invention may comprise various formats, including, but is not limited to, overall score, ranking, numerical value, letter designation, graphical symbol, graphical representation, etc. By acquiring information and data from numerous internal and external sources, the method of the present invention dynamically creates the business rating through computation with and without weighting factors, at least one artificial intelligence (AI) technology, including, but not limited to, natural language processing (NLP), which is used in the method to identify and convert any non-quantitative rating data/information into quantitative values. Further, the method combines the resulting business rating with relevant information of the specific business into a rating widget, which can be configured to form a dynamic and interactive display to be presented to the users and consumers of the specific business. Thus, the method of the present invention offers the users and/or consumers the overall rating of a business to facilitate an informed decision-making about the reputability and professionalism of the specific business.

### BRIEF DESCRIPTION OF THE DRAWINGS

FIG. 1 is a system diagram of the present invention.

FIG. 2 is a flowchart of an overall process of the method of the present invention.

FIG. 3 is a flowchart of a sub-process for acquiring business website of the method of the present invention.

FIG. 4 is a flowchart of a sub-process for acquiring business data of the method of the present invention, wherein a plurality of external sources is searched.

FIG. 5 is a flowchart of an alternative embodiment of the sub-process for acquiring business data of the method of the present invention, wherein reviews and comments are acquired.

FIG. 6 is a flowchart of an alternative embodiment of the sub-process for acquiring business data of the method of the present invention, wherein external databases are searched.

FIG. 7 is a flowchart of a sub-process for generating a business rating of the method of the present invention, wherein quantitative ratings are used for generating the rating.

FIG. 8 is a flowchart of an alternative embodiment of the sub-process for generating a business rating of the method of the present invention, wherein a weighted average rating is calculated.

FIG. 9 is a flowchart of another embodiment of the sub-process for generating a business rating of the method of the present invention, wherein a weighting factor for each quantitative rating input is determined.

FIG. 10 is a flowchart of another embodiment of the sub-process for generating a business rating of the method of the present invention, wherein non-quantitative business data are converted into quantitative rating data.

FIG. 11 is a flowchart of another embodiment of the sub-process for generating a business rating of the method of the present invention, wherein non-quantitative business data are processed using natural language processing (NLP) technology.

FIG. 12 is a flowchart of another embodiment of the sub-process for generating a business rating of the method of the present invention, wherein the business rating is recalculated and updated based on newly acquired information.

FIG. 13 is a flowchart of a sub-process for displaying a rating widget of the method of the present invention, wherein the business information and rating are combined into the rating widget.

FIG. 14 is a flowchart of an alternative embodiment of the sub-process for displaying a rating widget of the method of the present invention, wherein a business logo is combined into the rating widget.

FIG. 15 is a flowchart of another embodiment of the sub-process for displaying a rating widget of the method of the present invention, wherein update information of the rating is combined into the rating widget.

FIG. 16 is a flowchart of another embodiment of the sub-process for displaying a rating widget of the method of the present invention, wherein the rating is formatted on the rating widget.

FIG. 17 is a flowchart of another embodiment of the sub-process for displaying a rating widget of the method of the present invention, wherein a plurality of external ratings is combined into the rating widget.

FIG. 18 is a flowchart of another embodiment of the sub-process for displaying a rating widget of the method of the present invention, wherein the plurality of external ratings is displayed on the rating widget when the overall business rating is selected.

FIG. 19 is an illustration showing one embodiment of the rating widget of the present invention with display combinations.

### DETAIL DESCRIPTIONS OF THE INVENTION

All illustrations of the drawings are for the purpose of describing selected versions of the present invention and are not intended to limit the scope of the present invention.

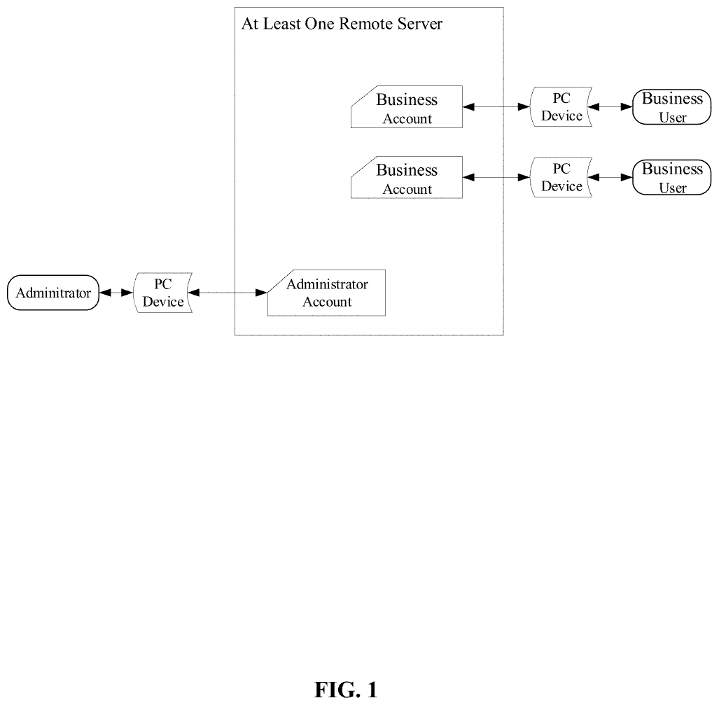

As can be seen in FIG. 1 to FIG. 19, the present invention comprises a method and system for providing a rating to a business using various quantitative data and non-quantitative information. The business rating of the present invention includes, but is not limited to, credibility rating, overall rating, industry standing, customer satisfaction rating, any combined rating thereof, any rating by a third-party organization, chamber of commerce, business bureau, any other government entity, any independent rating/ranking organization, or any other suitable rating. Additionally, the format of the business rating comprises, but is not limited to, overall score, ranking, numerical value, letter designation, graphical symbol, graphical representation, etc. Using information and data from numerous internal and external sources, the method of the present invention dynamically generates the business rating for the business through computation with and without weighting factors, at least one artificial intelligence (AI) technology, including, but not limited to, natural language processing (NLP), etc. Further, the method relays the rating to a user of the specific business through a rating widget, which can be configured to form a dynamic and interactive display. Thus, the method of the present invention presents to the user and/or consumers the overall rating of a business to facilitate an informed decision-making about the reputability and professionalism of the specific business.

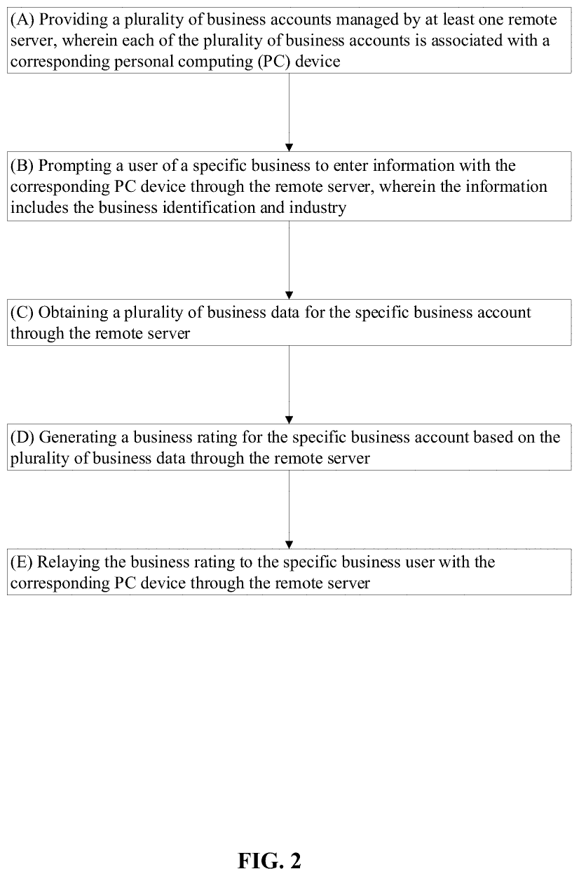

As can be seen in FIG. 1, the method of the present invention comprises a system and method to manage an online business rating platform for a plurality of business users. To accomplish this, the method associates each of the plurality of business users with a unique business account from a plurality of business accounts that are managed by at least one remote server (Step A), as seen in FIG. 2. Each of the plurality of business accounts is associated with a corresponding personal computing (PC) device. The corresponding PC device allows the user to interact with the present invention and can include, but is not limited to, a smartphone, a smart watch, a laptop, a desktop, a server, a server computer, a cloud computing device, a cloud computer, a personal digital assistant (PDA), a server terminal, a tablet PC, etc. The business users of the business accounts may include relevant parties such as, but are not limited to, individuals, businesses, entities, consumers, managers, business owners, companies, corporations, associations, organizations, non-profit organizations, government entities, automobile dealerships, new car sales outlets, used car sales outlets, restaurants, food catering services, food carryout operations, cafeterias, college/university dining halls, catering and vending companies, hotels and inns, and administrators, etc. Further, the at least one remote server is used to manage the honesty and credibility rating system for the plurality of business user accounts. The remote server can be managed through an administrator account by an administrator as seen in FIG. 1. The administrator who manages the remote server includes, but is not limited to, technician, engineer, system specialist, system administrator, software engineer, IT (information technology) specialist, IT professional, computer engineer, computer scientist, computer technologist, consultant, manager, owner, executive officer, chief operating officer, chief technology officer, chief executive officer, president, company, corporation, organization, association, etc. Moreover, the remote server is used to execute a number of internal software processes and store data for the present invention. The software processes may include, but are not limited to, server software programs, web-based software applications or browsers embodied as, for example, but not limited to, websites, web applications, cloud applications, desktop applications, laptop applications, server applications, and mobile applications, etc., compatible with a corresponding user PC device. Additionally, the software processes may store data into internal databases and communicate with external databases, which may include, but are not limited to, business user profile databases, personal information databases, business databases maintaining data about credit report, business standings, industry information/data, etc. The interaction with external databases over a communication network may include, but is not limited to, the Internet. Additionally, the term “business” is interchangeable with “entity” hereafter.

As can be seen in FIG. 2, the overall process of the method of the present invention prompts a user of a specific business to enter information with the corresponding PC device through the remote server, wherein the information includes the business identification and industry (Step B). More specifically, the method prompts the specific business user to enter data including, but not limited to, business name, address, phone number, state and/or federal registration numbers, owner, chief executive officer, etc., in order to create a business account with a profile in the system of the present invention. The industry of the present invention may include, but is not limited to, automobile local distribution industry, the food services industry, the retail industry, the electronic commerce (e-commerce) industry, the trade industry, the entertainment industry, the real estate industry, the construction industry, etc. These pieces of information are essential to identify the business accurately, which are later used by the method to acquire rating related data/information for the business from external sources. With the appropriate business information, the method obtains a plurality of business data for the specific business account through the remote server (Step C). Specifically, the method may extensively search internal and/or external sources, including, but not limited to, databases, websites, reports, data tables, comments, consumer reports, rating/ranking reports/data, government databases/reports, various online review sites, websites, and creditors, including, but not limited to, Yelp®, Google®, Yahoo®, Facebook®, Twitter®, Bing®, Trip Advisor®, Amazon®, Consumer Reports®, Yellow Pages®, etc. Additionally, the plurality of business data and/or files include, but are not limited to, rating/ranking record, consumer report record, customer satisfaction record, customer complaint record, product return record, customer feedback record, credibility record, industry standing report, bankruptcy record, foreclosure record, civil judgement record, court proceeding record, record of violations of the law, business operation record, business history record, tax record, community record, any other suitable documents, etc. Upon acquiring the plurality of business data, the method generates a business rating for the specific business account based on the plurality of business data through the remote server (Step D). In the preferred embodiment of the present invention, a unique rating algorithm is used by the method to process the plurality of business data which may comprise both quantitative and non-quantitative data and calculate an overall rating in this step. Subsequently, the method relays the business rating to the specific business user with the corresponding PC device through the remote server (Step E) for the display and interactive presentation of the business rating widget to the specific business user and/or consumers.

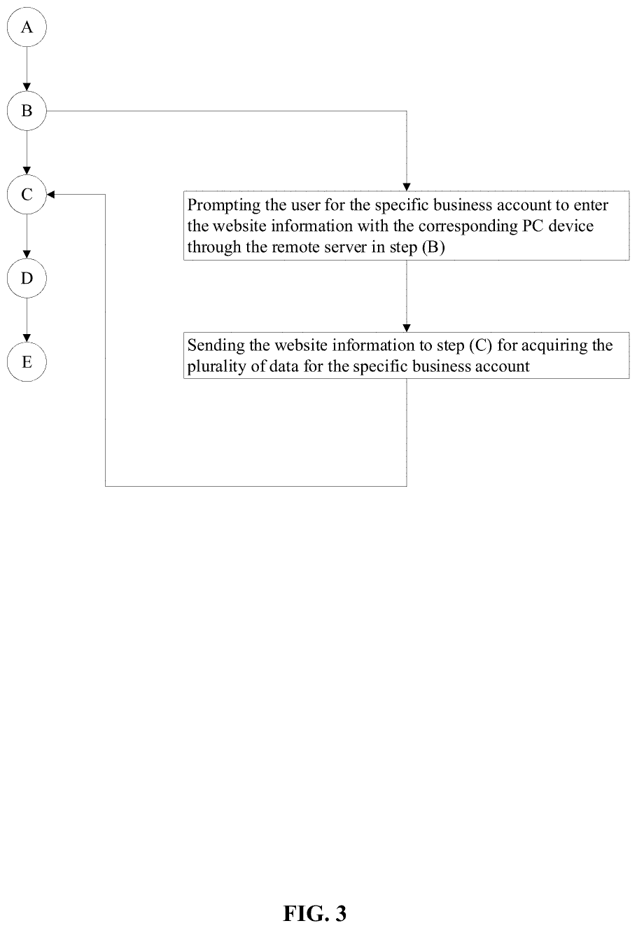

As can be seen in FIG. 3, the method of the present invention provides a sub-process for acquiring business website. More specifically, the method prompts the user for the specific business account to enter the website information with the corresponding PC device through the remote server in Step B. Subsequently, the method sends the website information to Step C for acquiring the plurality of data for the specific business account.

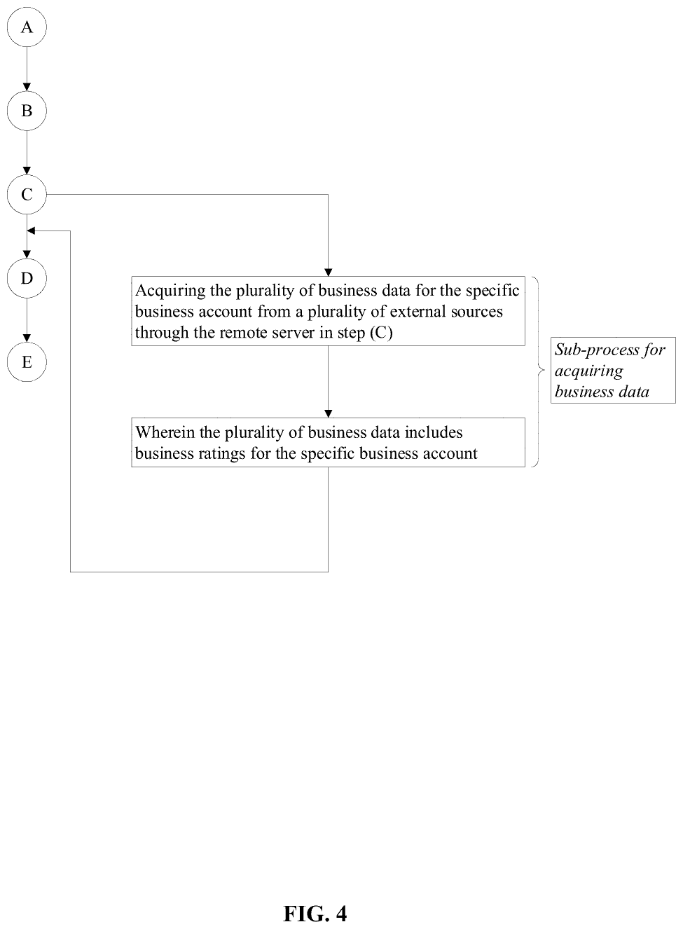

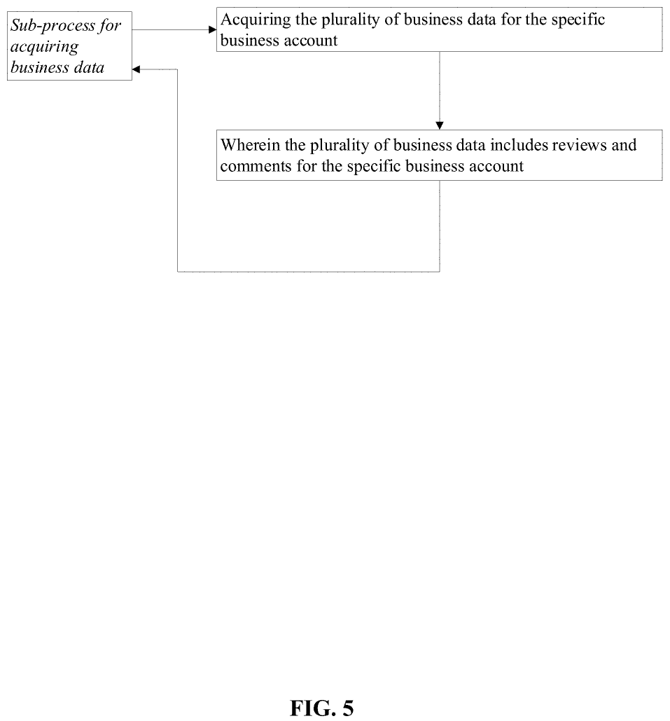

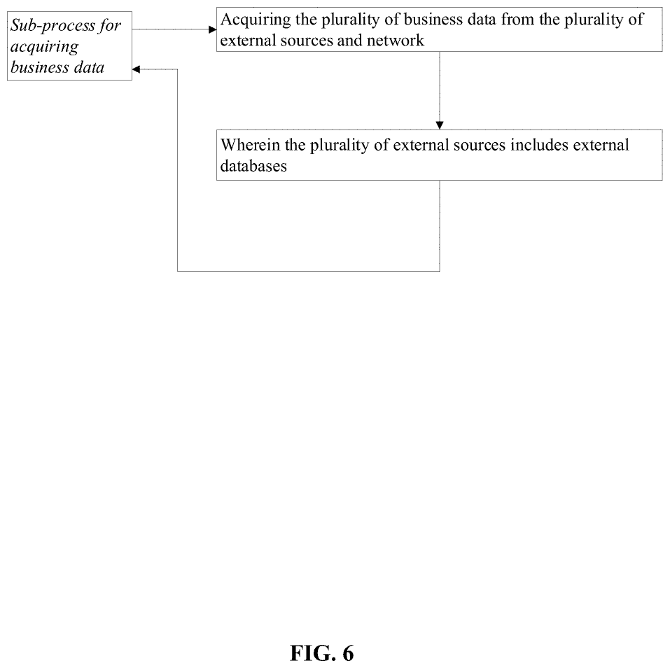

As can be seen in FIG. 4, in the preferred embodiment of the present invention, the method provides a sub-process for acquiring business data. Specifically, the method acquires the plurality of business data for the specific business account from a plurality of external sources through the remote server in Step C, wherein the plurality of business data includes business ratings for the specific business account. The business ratings may include, but are not limited to, numerical ratings/rankings, numerical standings, ratings/ranking designated in letters, symbols, graphical representations, etc. As can be seen in FIG. 5, in an alternative embodiment, the method acquires the plurality of business data for the specific business account, wherein the plurality of business data includes reviews and comments for the specific business account. The business reviews and comments may include, but are not limited to, customer/consumer review/feedback records, association reviews, government entity's reviews/reports, any complaints, any investigations, any recalls, etc. As can be seen in FIG. 6, in another embodiment, the method acquires the plurality of business data from the plurality of external sources and network, wherein the plurality of external sources includes external databases.

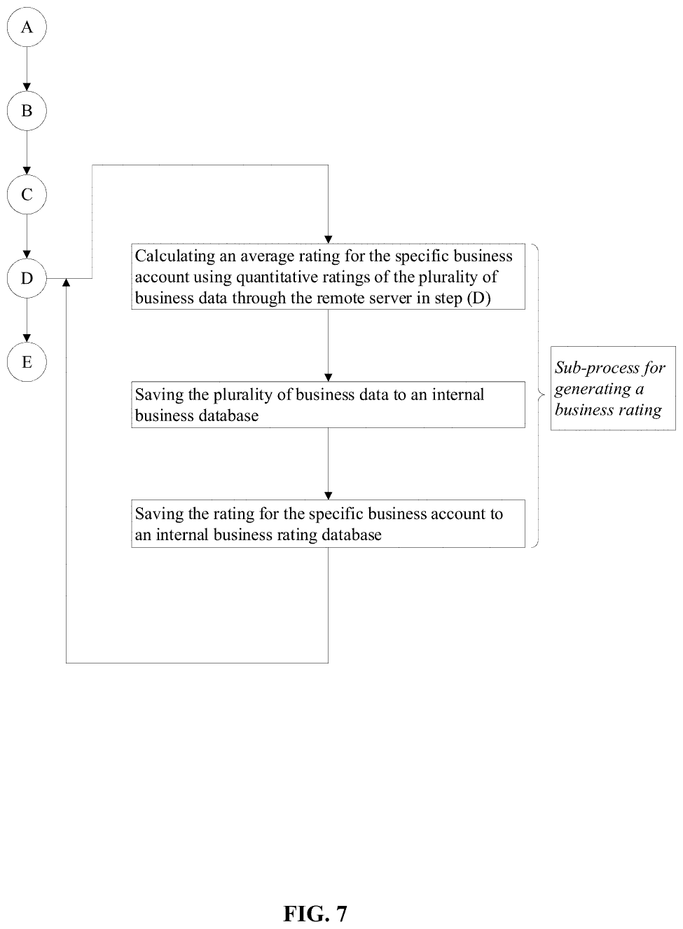

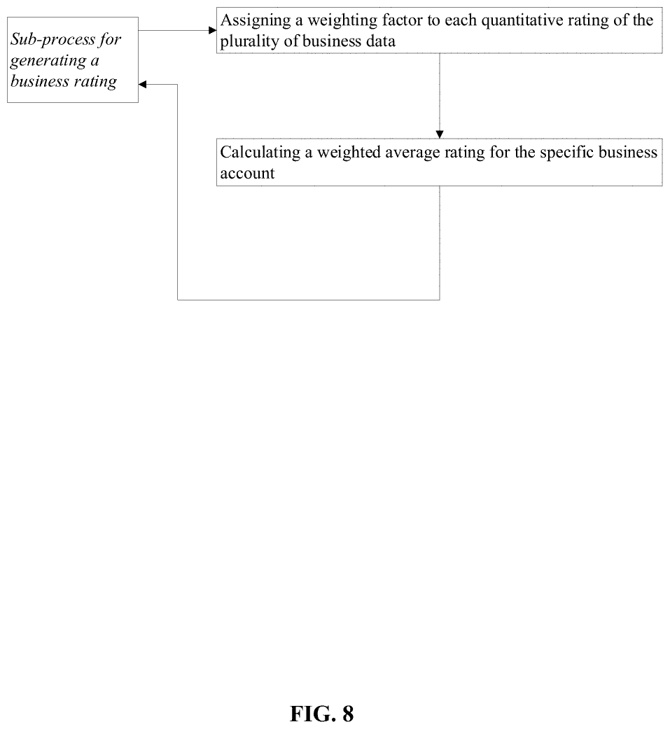

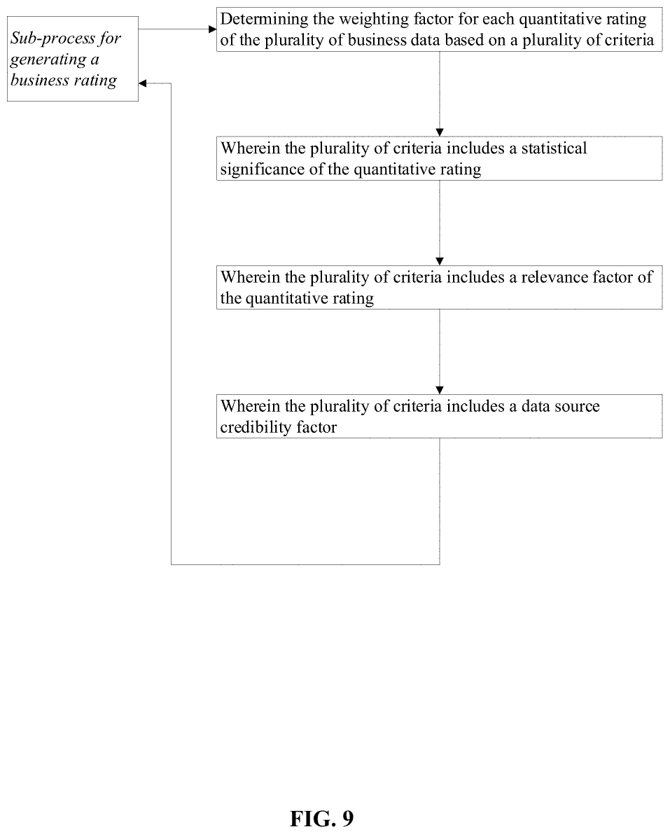

As can be seen in FIG. 7, the method provides a sub-process for generating a business rating. Specifically, the method calculates an average rating for the specific business account using quantitative ratings of the plurality of business data through the remote server in Step D. Subsequently, the method saves the plurality of business data to an internal business database and the resulting rating for the specific business account to an internal business rating database. As can be seen in FIG. 8, in an alternative embodiment of the present invention, the sub-process of the method assigns a weighting factor to each quantitative rating of the plurality of business data, and then calculates a weighted average rating for the specific business account. As can be seen in FIG. 9, the method may determine the weighting factor for each quantitative rating of the plurality of business data based on a plurality of criteria, wherein the plurality of criteria includes a relevance factor of the quantitative rating. Additionally, the plurality of criteria may include, but is not limited to, a statistical significance of the quantitative rating, a data source credibility factor, etc. The rating algorithm may assign a higher weighting factor to a quantitative rating with a higher relevance, a higher statistical significance, and a higher data source credibility than that one with lower ones.

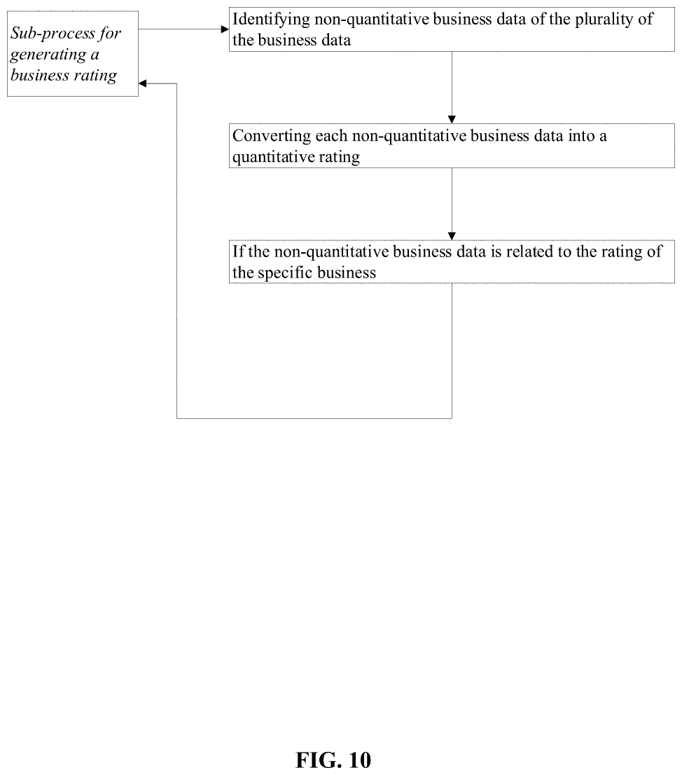

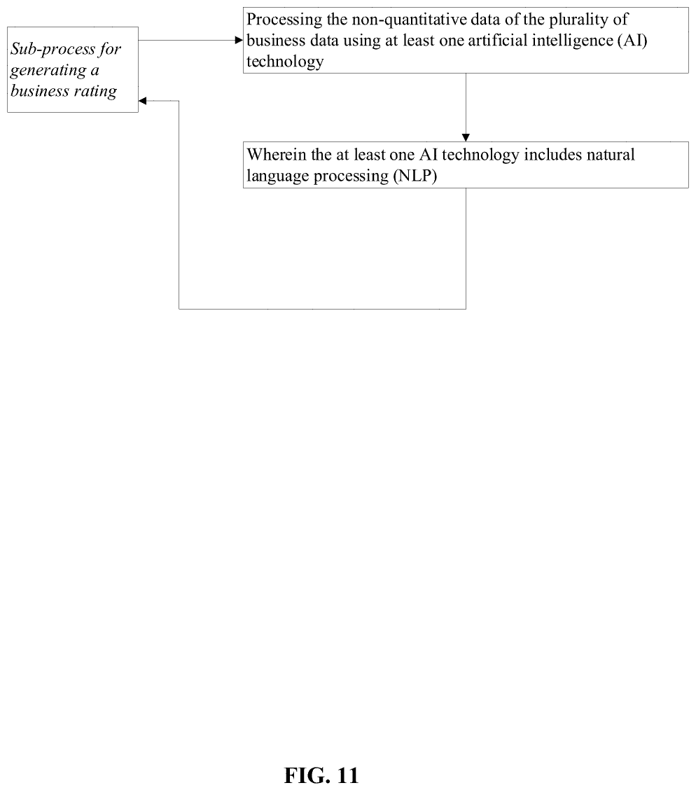

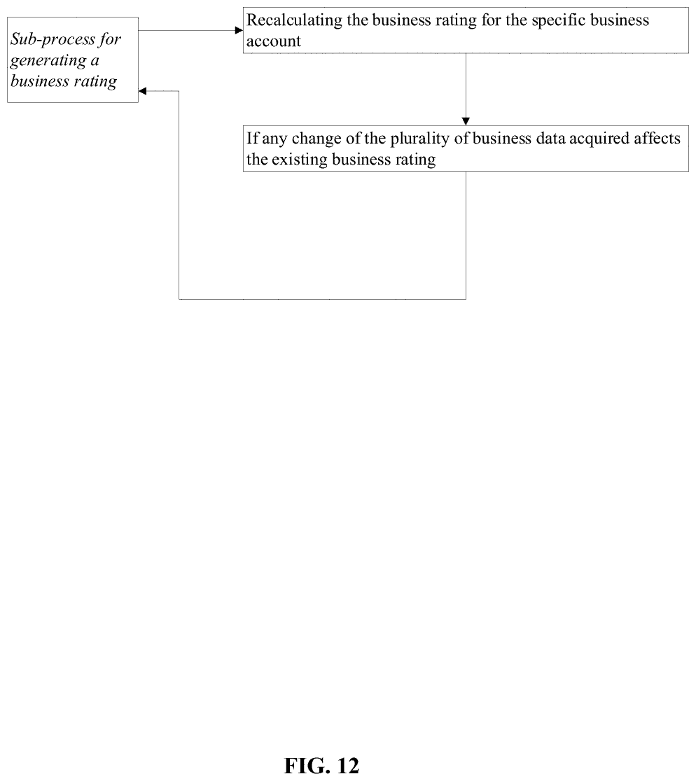

As can be seen in FIG. 10, in an alternative embodiment of the present invention, the sub-process for generating a business rating of the method identifies non-quantitative business data of the plurality of the business data, if the plurality of business data comprises at least one piece of non-quantitative information which may include, but are not limited to, revies, comments, complaints, business financial data, tax records, court proceedings, rankings, etc. Subsequently, the method converts each non-quantitative business data into a quantitative rating if the non-quantitative business data is related to the rating of the specific business. Any irrelevant data is then saved into the internal business databases for the specific business, but not used in the rating generating algorithm. As can be seen in FIG. 11, in another embodiment, the method processes the non-quantitative data of the plurality of business data using at least one artificial intelligence (AI) technology wherein the at least one AI technology includes natural language processing (NLP). As can be seen in FIG. 12, in yet another embodiment, the method recalculates the business rating for the specific business account if any change of the plurality of business data acquired affects the existing business rating. Additionally, the method may conduct rating update and/or recalculation following a predetermined schedule, an ad hoc arrangement, a notification of business information update from any external source, etc.

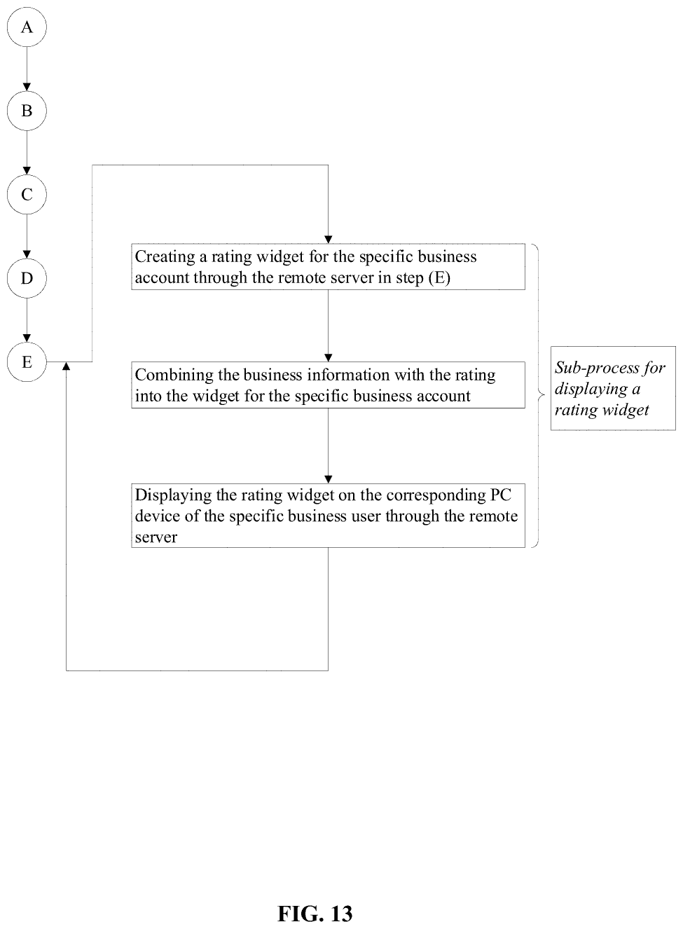

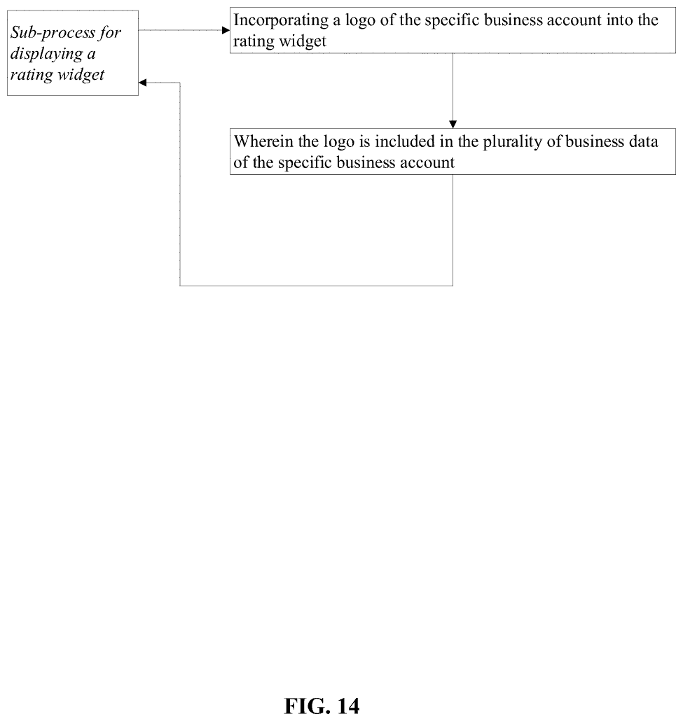

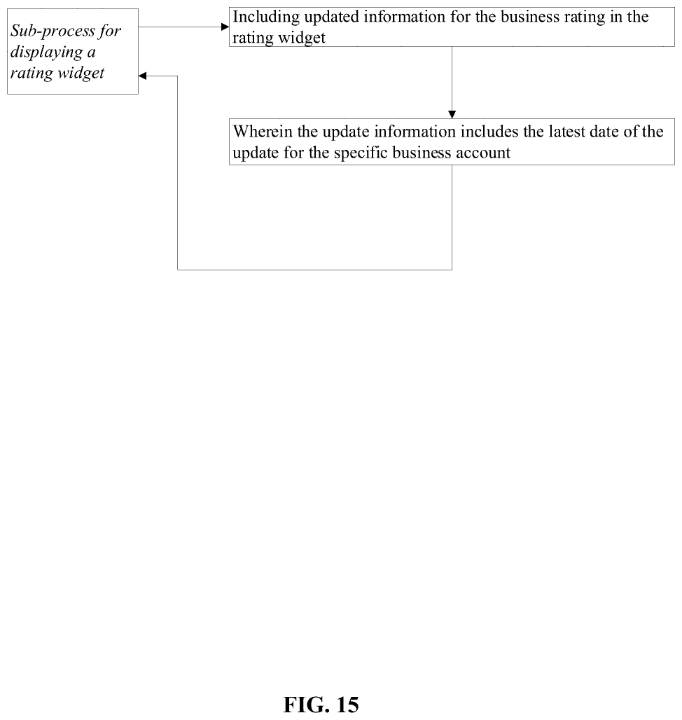

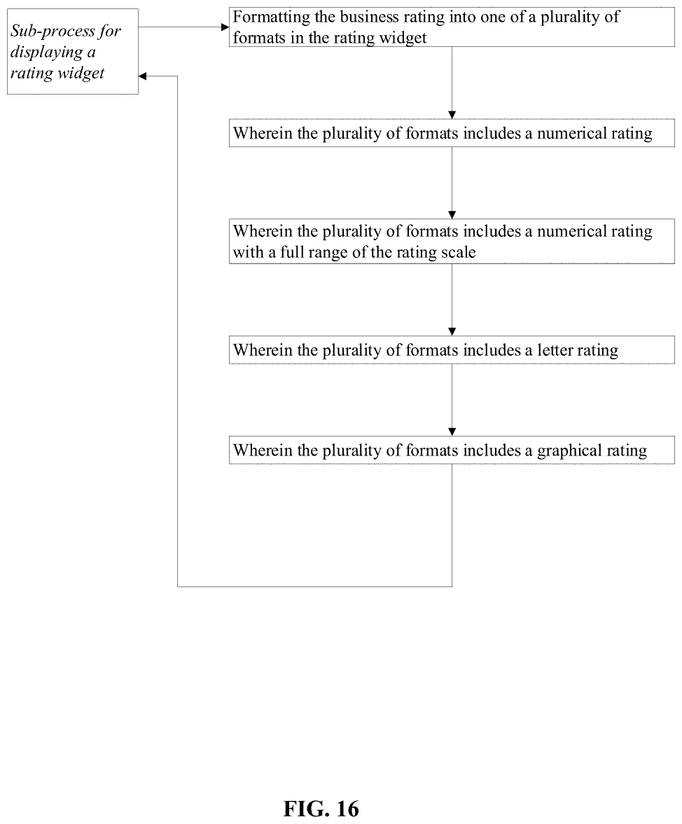

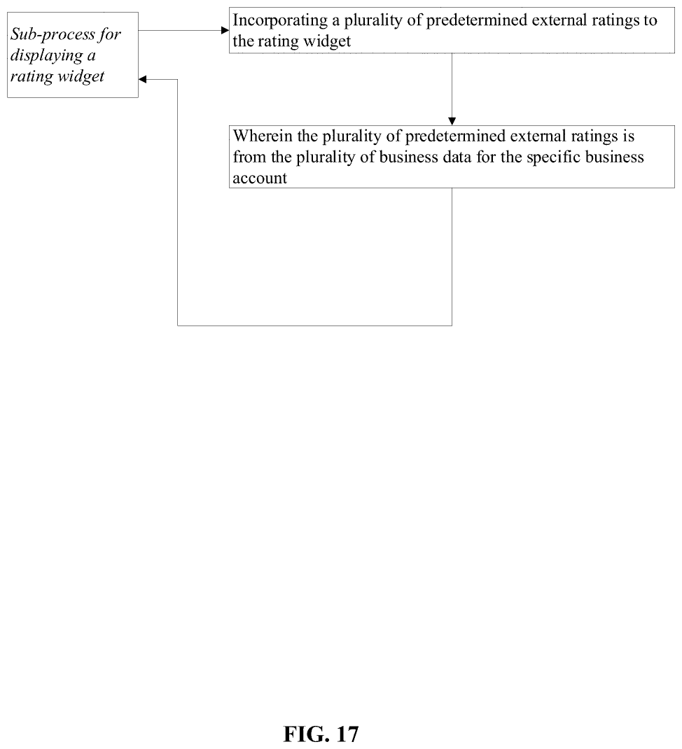

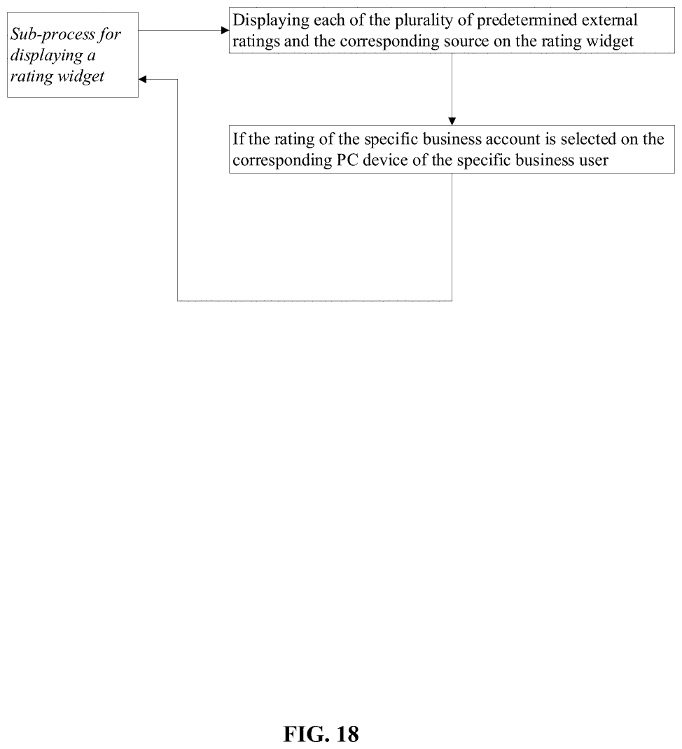

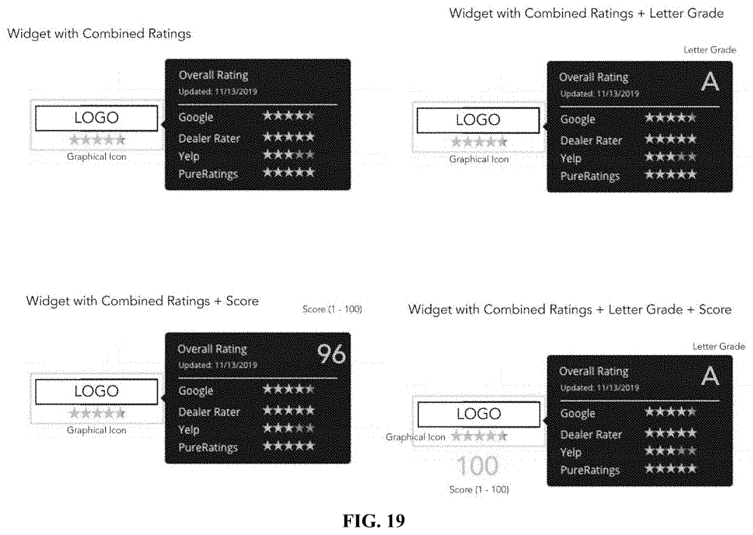

As can be seen in FIG. 13 and FIG. 19, the method provides a sub-process for displaying a rating widget. Specifically, the method creates a rating widget for the specific business account through the remote server in Step E, which can be used on the corresponding PC device of the specific business user. Subsequently, the method combines the business information with the rating into the widget for the specific business account, and displays the rating widget on the corresponding PC device of the specific business user through the remote server. As can be seen in FIG. 14, in an alternative embodiment, the method incorporates a logo of the specific business account into the rating widget, wherein the logo is included in the plurality of business data of the specific business account. Additionally, the method may comprise, but is not limited to, a permission response to use the log of the specific business account from the specific business user before incorporating the logo into the widget. As can be seen in FIG. 15, in another embodiment, the method includes updated information for the business rating in the rating widget, wherein the update information includes the latest date of the update for the specific business account. Thus, the rating widget may include, but is not limited to, the latest update information and date. As can be seen in FIG. 16, in yet another embodiment, the method formats the business rating into one of a plurality of formats in the rating widget. The plurality of formats may include, but is not limited to, a numerical rating, a numerical rating with a full range of the rating scale, a letter rating, a graphical rating, etc. As can be seen in FIG. 17, in another embodiment, the method incorporates a plurality of predetermined external ratings to the rating widget, wherein the plurality of predetermined external ratings is from the plurality of business data for the specific business account. As can be seen in FIG. 18 and FIG. 19, in yet another embodiment, the method displays each of the plurality of predetermined external ratings and the corresponding source on the rating widget, if the rating of the specific business account is selected on the corresponding PC device of the specific business user. Additionally, the plurality of predetermined external ratings and the corresponding source are presented/displayed on the rating widget when the pointing device of the corresponding PC device, e.g., mouse, keyboard pointer, tablet stylus, etc., moves to the overall rating of the specific business account on the rating widget.

Although the invention has been explained in relation to its preferred embodiment, it is to be understood that many other possible modifications and variations can be made without departing from the spirit and scope of the invention as hereinafter claimed.

What is claimed is:

1. A method for providing a business rating using quantitative and non-quantitative information, the method comprising the steps of:
(A) providing a plurality of business accounts managed by at least one remote server, wherein each of the plurality of business accounts is associated with a corresponding personal computing (PC) device;
(B) prompting a user of a specific business to enter information with the corresponding PC device through the remote server, wherein the information includes the business identification and industry;
(C) obtaining a plurality of business data for the specific business account through the remote server;
(D) generating a business rating for the specific business account based on the plurality of business data through the remote server;
(E) relaying the business rating to the specific business user with the corresponding PC device through the remote server.

2. The method for providing a business rating using quantitative and non-quantitative information as claimed in claim 1, the method comprising the steps of:
prompting the user for the specific business account to enter the website information with the corresponding PC device through the remote server in step (B); and
sending the website information to step (C) for acquiring the plurality of data for the specific business account.

3. The method for providing a business rating using quantitative and non-quantitative information as claimed in claim 1, the method comprising the steps of:
acquiring the plurality of business data for the specific business account from a plurality of external sources through the remote server in step (C); and
wherein the plurality of business data includes business ratings for the specific business account.

4. The method for providing a business rating using quantitative and non-quantitative information as claimed in claim 3, the method comprising the steps of:
acquiring the plurality of business data for the specific business account; and
wherein the plurality of business data includes reviews and comments for the specific business account.

5. The method for providing a business rating using quantitative and non-quantitative information as claimed in claim 3, the method comprising the steps of:
acquiring the plurality of business data from the plurality of external sources and network; and
wherein the plurality of external sources includes external databases.

6. The method for providing a business rating using quantitative and non-quantitative information as claimed in claim 1, the method comprising the steps of:
calculating an average rating for the specific business account using quantitative ratings of the plurality of business data through the remote server in step (D);
saving the plurality of business data to an internal business database; and
saving the rating for the specific business account to an internal business rating database.

7. The method for providing a business rating using quantitative and non-quantitative information as claimed in claim 6, the method comprising the steps of:
assigning a weighting factor to each quantitative rating of the plurality of business data; and
calculating a weighted average rating for the specific business account.

8. The method for providing a business rating using quantitative and non-quantitative information as claimed in claim 6, the method comprising the steps of:
determining the weighting factor for each quantitative rating of the plurality of business data based on a plurality of criteria;
wherein the plurality of criteria includes a relevance factor of the quantitative rating; and
wherein the plurality of criteria includes a statistical significance of the quantitative rating.

9. The method for providing a business rating using quantitative and non-quantitative information as claimed in claim 8, the method comprising the steps of:
wherein the plurality of criteria includes a data source credibility factor.

10. The method for providing a business rating using quantitative and non-quantitative information as claimed in claim 6, the method comprising the steps of:
identifying non-quantitative business data of the plurality of the business data;
converting each non-quantitative business data into a quantitative rating; and
if the non-quantitative business data is related to the rating of the specific business.

11. The method for providing a business rating using quantitative and non-quantitative information as claimed in claim 10, the method comprising the steps of:
processing the non-quantitative data of the plurality of business data using at least one artificial intelligence (AI) technology; and
wherein the at least one AI technology includes natural language processing (NLP).

12. The method for providing a business rating using quantitative and non-quantitative information as claimed in claim 6, the method comprising the steps of:
recalculating the business rating for the specific business account; and
if any change of the plurality of business data acquired affects the existing business rating.

13. The method for providing a business rating using quantitative and non-quantitative information as claimed in claim 1, the method comprising the steps of:
creating a rating widget for the specific business account through the remote server in step (E);
combining the business information with the rating into the widget for the specific business account; and
displaying the rating widget on the corresponding PC device of the specific business user through the remote server.

14. The method for providing a business rating using quantitative and non-quantitative information as claimed in claim 13, the method comprising the steps of:
incorporating a logo of the specific business account into the rating widget; and
wherein the logo is included in the plurality of business data of the specific business account.

15. The method for providing a business rating using quantitative and non-quantitative information as claimed in claim 13, the method comprising the steps of:
including updated information for the business rating in the rating widget; and
wherein the update information includes the latest date of the update for the specific business account.

16. The method for providing a business rating using quantitative and non-quantitative information as claimed in claim 13, the method comprising the steps of:
formatting the business rating into one of a plurality of formats in the rating widget;
wherein the plurality of formats includes a numerical rating;
wherein the plurality of formats includes a numerical rating with a full range of the rating scale;
wherein the plurality of formats includes a letter rating; and
wherein the plurality of formats includes a graphical rating.

17. The method for providing a business rating using quantitative and non-quantitative information as claimed in claim 13, the method comprising the steps of:
incorporating a plurality of predetermined external ratings to the rating widget; and
wherein the plurality of predetermined external ratings is from the plurality of business data for the specific business account.

18. The method for providing a business rating using quantitative and non-quantitative information as claimed in claim 13, the method comprising the steps of:
displaying each of the plurality of predetermined external ratings and the corresponding source on the rating widget; and
if the rating of the specific business account is selected on the corresponding PC device of the specific business user.

19. The method for providing a business rating using quantitative and non-quantitative information as claimed in claim 1, the method comprising the steps of:
wherein the industry includes automobile local distribution industry.

20. The method for providing a business rating using quantitative and non-quantitative information as claimed in claim 1, the method comprising the steps of:
wherein the industry includes food services industry.
